(19) United States
(12) Patent Application Publication
(10) Pub. No.: US 2004/0039646 A1
(43) Pub. Date: Feb. 26, 2004

(54) Automobile inventory engine

(75) Inventor: Bruce Hacker, Virginia Beach, VA (US)

Correspondence Address: Stephen C. Glazier, Kirkpatrick & Lockhart LLP, 1800 Massachusetts Avenue, NW, 2nd Floor, Washington, DC, 20036-1800, US

(73) Assignee: Reynolds and Reynolds Holdings, Inc., Dayton, OH

(21) Appl. No.: 10/226,568

(22) Filed: Aug. 22, 2002

(51) Int. Cl. G06F 17/60; G06G 1/14

(52) U.S. Cl. 705/22

(57) ABSTRACT

In the disclosed automobile inventory system and methods, automobile report data is received from information sources having incompatible data formats. The report data is reformatted in a uniform format. A vehicle identification number (VIN) for the automobile is decoded to produce a set of automobile attributes. Attributes are matched with received third party automobile report data. A photograph is selected to represent the automobile. The color of the selected photograph substantially matches an identified color of the automobile. A database is populated with database data, including the reformatted report data, attribute matching data, and data associated with the colorized photograph. The database data is filtered or modified based on at least one dealer business rule, and the database data is electronically communicated to a World Wide Web accessible server. The database data is updated in real time.

### BACKGROUND

1. Field

Embodiments of the present invention relate to automobile inventory systems and methods.

2. Description of Related Art

The automobile industry is among the dominant world industries, having complex distribution channels encompassing a multiplicity of persons and entities. In an exemplary scenario, a new car is manufactured, delivered to a dealer, and purchased by a consumer from the dealer. At some time in the future, the consumer may elect to trade in his or her used car, and the dealer may place the used car on sale for purchase by another consumer.

In general, car manufacturers produce multiple makes (product lines), each of which may be offered in numerous models. Each model, in turn, may be available in a host of styles, colors, and options, which may be varied to yield differing product configurations. Relatively few consumers buy cars without considering at least one or more of such variables. Some consumers even consider scores of variables, refusing to buy any car that falls short of the particular consumer's “dream car.”

Inventory at car dealerships is constantly in flux. This state of change hampers decisionmaking by consumers, for a consumer may not be assured that a certain vehicle with desired features is available for purchase at the dealership. As such, computerized automobile inventory systems have been developed to manage automobile inventory information.

Some of these prior art inventory systems may be accessed by automobile buyers via the World Wide Web (WWW) over graphical user interfaces (GUIs). However, such systems are not updated in real time and thus often provide obsolete information that, for example, offers cars for sale on the Web that are no longer available. Additionally, these systems can provide web access to data from only one source and cannot integrate, onto one GUI, information about a single vehicle provided by various third party systems because the third party sources utilize distinct incompatible data formats.

Accordingly, there is a frustrated need to provide Web access to real-time updated automobile inventories for sales or other purposes, which access integrates information for a given vehicle onto a single GUI, which information comes from a variety of sources with incompatible data formats.

### SUMMARY

Embodiments of the present invention provide for a data inventory engine.

The present invention for the first time provides Web access to real-time updated vehicle inventory information, which access integrates, for a given vehicle, information from a plurality of third party information providers that provide information in distinct, incompatible formats.

In an embodiment useful for the automobile industry, automobile inventory data is gathered in real time from various sources. The data relates to automobiles sold by dealers, and may include any information relating to a particular automobile, such as manufacturer, division, model, style, stylecode, color, vehicle identification number (VIN), make, model, and color. The various sources, such as dealer management systems (DMSs) and sticker service companies, may supply data in distinct, incompatible formats. The gathered data is reformatted to conform to a single uniform custom format for embodiments of the present invention. Additional automobile attributes may be determined by decoding the VIN of a vehicle and also by matching decoded attributes with data received from third party information providers. In one embodiment, a photograph is selected to represent a particular automobile and colorized to substantially match an identified color of the particular automobile.

A database may be populated with the reformatted data, including the attributes determined by matching, as well as with information relating to the colorized photograph. Database data may be filtered and modified according to dealer criteria, such as business rules or custom logic.

A user, such as a dealer or customer, may then access the filtered and modified database data, including textual information and the colorized photograph of the automobile, via the World Wide Web, in order to buy cars or for other purposes.

In other embodiments, gathered inventory data is stored in a data warehouse for future use.

### BRIEF DESCRIPTION OF THE DRAWINGS

FIG. 1 illustrates an inventory system according to an embodiment of the present invention.

FIG. 2 illustrates an automobile inventory system according to an embodiment of the present invention.

FIG. 3 illustrates an inventory system according to an embodiment of the present invention.

FIG. 4 illustrates an inventory system according to an embodiment of the present invention.

FIG. 5 illustrates an inventory system according to an embodiment of the present invention.

FIG. 6 is a flowchart of a process for an automobile inventory system according to an embodiment of the present invention.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

Embodiments of the present invention provide for methods and systems for delivering real-time automobile inventory information to a user over the World Wide Web (WWW).

In one embodiment, automobile report data is received from information sources having respective data formats. The report data relates to at least one automobile associated with a dealer location. The report data is reformatted in a custom format. A vehicle identification number (VIN) for the automobile is decoded to produce a set of automobile attributes. Attributes are matched with received third party automobile report data. A photograph is selected to represent the automobile and colorized to substantially match an identified color of the automobile. A database is populated with database data, including the reformatted report data and optionally data associated with the colorized photograph. The database data is filtered and modified based on at least one dealer criterion, and the filtered and modified database data is made available to a user via the World Wide Web. The database data is updated in real time.

Various embodiments of the present invention have been implemented by Automark, LLC (Va. Beach, Va.) as Automark Web Services.

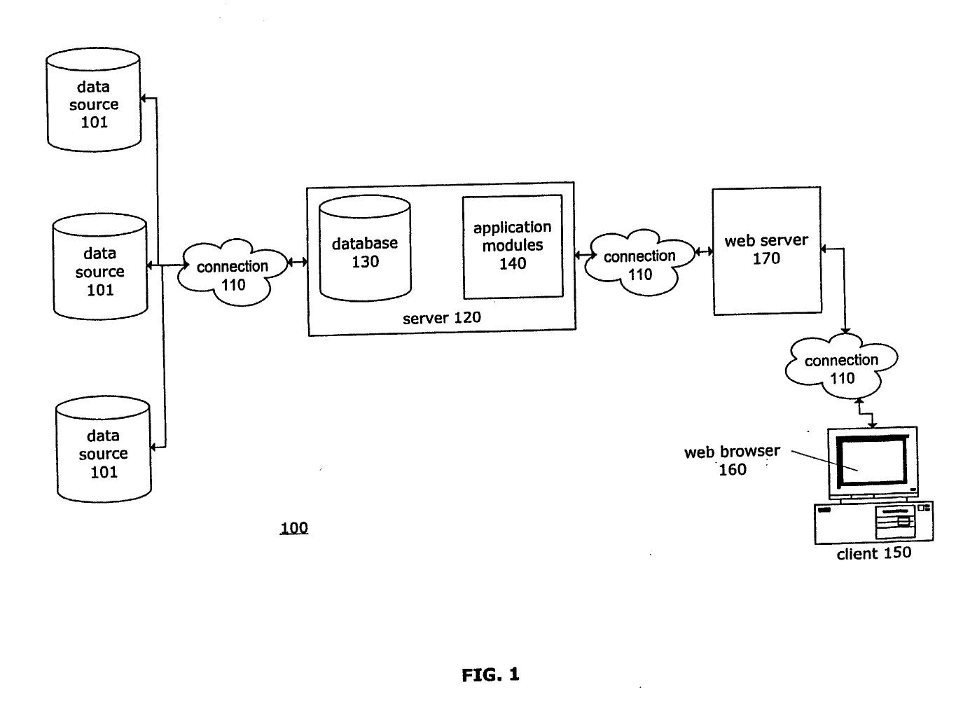

FIG. 1 illustrates an inventory system 100 according to an embodiment of the present invention. System 100 includes various data sources 101, a server 120, a web server 170, and a client 150. System 100 may be implemented in the automobile industry, as well as in other settings wherein data is received, processed, and then transmitted and/or otherwise made accessible to users.

Server 120 includes a database 130 and application modules 140. Client 150 runs a web browser 160, such as Microsoft Internet Explorer or Netscape Communicator.

When implemented in an automobile setting, server 120 receives automobile report data, via a connection 110, from various data sources 101. Connection 110 may include one or more wired or wireless connections over the Internet and/or other suitable networks.

Data sources 101 may include one or more information providers, such as dealers or third parties or sets thereof, that provide automobile report data of different kinds and/or in different formats. “Automobile” is used herein for ease of explanation, but embodiments of the present invention may be used for any vehicle, such as a car, truck, motorcycle, bicycle, boat, plane, mobile home, recreational vehicle (RV), trailer, or personal transportation vehicle, such as a wheelchair. A “third party” may be any entity that does not operate a dealership whose inventory is featured in a dealer webpage. “Automobile report data” may include any data that is useful to system 100, such as, for example, dealer inventory, specification, repair, pricing, dealer incentive, vehicle configuration, photograph, and sticker service information. Although three data sources are illustrated in FIG. 1, it is to be understood that more or fewer sources may be utilized. In an exemplary implementation, about two dozen sources are incorporated in system 100.

Application modules 140 process received data and store the processed data in database 130 or other remote or local databases.

Web server 170 electronically communicates, via connection 110, with server 120, which transmits data from database 130. Web server 170 may host one or more webpages whose information content or functions are all or partially derived from database 130 and/or application modules 140 in server 120.

Via connection 110, web browser 160 accesses web server 170. As such, a user, such as a consumer or dealer, may access automobile inventory information provided by server 120.

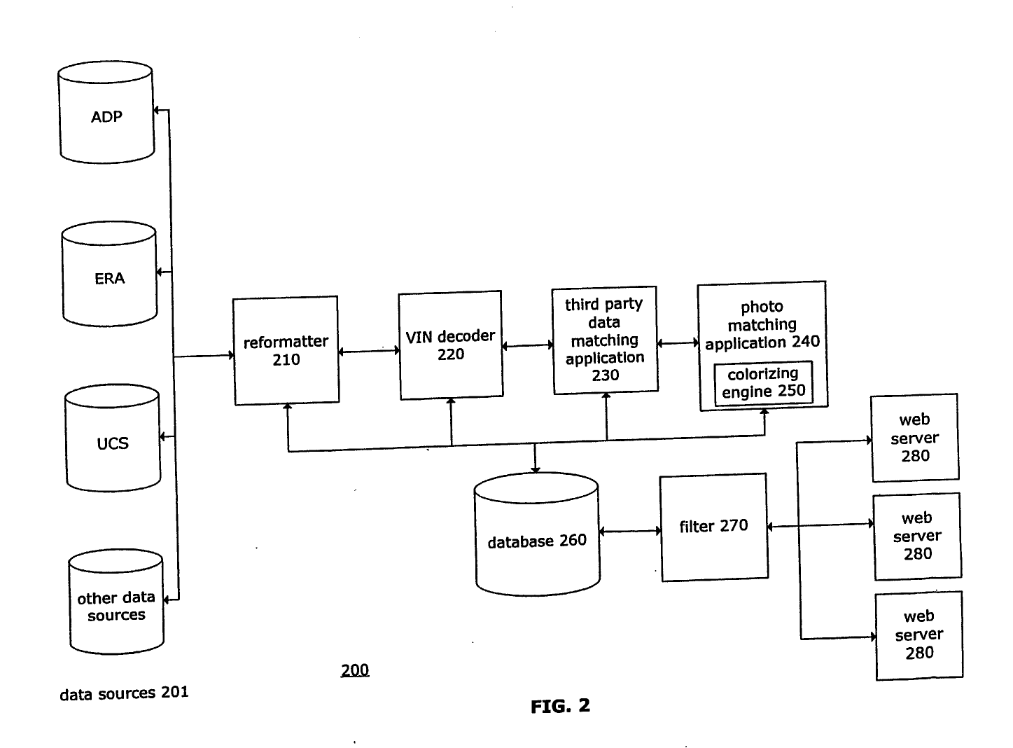

FIG. 2 illustrates an automobile inventory system 200 according to an embodiment of the present invention. System 200 may constitute a specific implementation of system 100 of FIG. 1. System 200 includes various data sources 201, a reformatter 210, a vehicle identification number (VIN) decoder 220, a third party data matching application 230, a photo matching application 240, a database 260, a filter 270, and various web servers 280. It is to be appreciated that an arbitrary number of data sources 201 and web servers 280 are depicted in FIG. 2; more or fewer may be incorporated in system 200. The various modules in system 200, or a subset thereof, may be implemented together or in separate devices and/or modules.

In some implementations, various modules in system 200 may be programmed in Java and run on Java-compatible operating system platforms, such as Linux.

Database 260 may be implemented as one or multiple databases. As shown, database 260 may be accessed by various modules in system 200 as inventory information is processed therein through operation and interaction of the various modules.

Data sources 201 are like data sources 101 described above. Exemplary data sources 201 may include (1) dealer management systems (DMSs), such as ADP, Inc., UCS, and ERA; (2) third party information providers, such as JATO Dynamics Ltd., Chrome Systems Corporation, Autodata Ltd., Kelley Blue Book, Edmunds.com, and Glass's Information Services Ltd.; and (3) sticker service companies, such as Dealer Specialties and Rolling Maroni, which may constitute another type of third party information provider. In system 200, for purposes of illustration, data sources 201 are respectively identified as ADP, ERA, UCS, and other data sources.

Respective data sources 201 may provide data that conforms to differing incompatible formats, such as proprietary formats. In addition, data sources 201 may contain information that overlaps with information in other data sources 201. In some cases, two or more data sources 201 may offer the same information, such as a maximum tire pressure specification for a particular tire, but the sources may report inconsistent information, such as differing numeric pressures for that specification.

Data feeds of data sources 201 may be provided and/or updated nightly, weekly, or at more frequent or less frequent intervals. Data sources 201 may provide data to reformatter 210 in various ways. For example, reformatter 210 may access systems of a data source 201 to acquire data. Alternatively or additionally, a data source 201 may post information by FTP (File Transfer Protocol) to reformatter 210 for individual transactions or sets thereof.

In other embodiments, data sources 201 may provide real-time data feeds to reformatter 210 via HTML (Hypertext Markup Language) over the Web. For instance, when a dealer completes a transaction, such as a sale of a vehicle, an associated data source 201 may send a transaction report to reformatter 210 (or another receiving module). System 200 may update database 260 based on the transaction information, and may send a confirmation of the update to the data source 201. In particular, a data source 201 (for example, a DMS for a dealer that has just completed an inventory transaction requiring a real-time update to database 260) may post an XML (Extensible Markup Language) message via HTTP (Hypertext Transfer Protocol) to reformatter 210 or another suitable receiving module in system 200. Reformatter 210 may then process the posted message, and system 200 may ascertain inventory changes. Data sources 201 may be individually configured to prepare and post such messages to software modules in system 200, which may include servlets (not shown). As such, system 200 is always on, that is, system 200 provides real-time updates of data.

For data sources 201 that provide an entire inventory report even when only a subset of report data has been changed, reformatter 210 may compare the provided inventory report with previously received reports to pinpoint changes to make to acquired data. For data sources 201 that provide inventory change information on a transaction-by-transaction basis, reformatter 210 may directly update data in system 200 by making additions or deletions thereto, which may facilitate real-time processing.

Reformatter 210 receives data conforming to respective formats of data sources 201. In an exemplary implementation, reformatter 210 reformats (parses) the received data to conform to a custom format for system 200. Thus, reformatter 210 receives data conforming to various formats and outputs the data in one or more normalized formats for further processing by system 200. The reformatted data may be stored in database 260.

In one implementation, reformatter 210 stores received data in one or more databases, such as database 260, or another nonvolatile or volatile memory, before reformatting such data.

VIN decoder 220 decodes vehicle identification numbers (VINs) associated with automobiles represented in report data from data sources 201. Each VIN contains encoded attributes of a vehicle, such as, for example, its country of origin, make, body style, model year, engine, and serial number. The decoded attributes may be stored in database 260 or another database. In one implementation, VIN data is used to populate an Oracle 8i database, such as database 260, and is updated weekly.

Third party data matching application 230 uses at least one of the decoded attributes to acquire additional relevant report data from information providers. For instance, in an exemplary implementation, VIN decoder 220 may determine from a VIN that the model year of the associated vehicle is 2002. Using that information, third party data matching application 230 may acquire report data from information providers that is pertinent to the 2002 model year.

In a particular embodiment, third party data matching application 230 receives as input a Java object representation of a dealer's inventory. Information in the representation may include the VIN of a vehicle, whether the vehicle is new or used, and a dealer-defined stock number for the vehicle. Third party data matching application 230 may use such information, along with any other supplied information and information decoded by VIN decoder 220, to acquire additional report data from information providers.

As such, third party data matching application 230 may facilitate building of a data set for a particular vehicle represented in the report data.

In an exemplary implementation, reformatter 210 and/or third party data matching application 230 correct errors in data by polling information from multiple data sources 201. Errors in data may be detected and corrected if, for example, an item of data from a particular data source differs from the counterpart item polled from other data sources. In some embodiments, if more sources report a value as X than do sources report a value Y, then the value is taken to be X. In other embodiments, values polled from sources that are known to have more timely and/or accurate information are utilized even if discrepancies exist between those values and values polled from other sources.

Photo matching application 240 selects one or more photographs to represent automobiles listed in the automobile report data. A selected photograph may be displayed or made accessible, such as by a hypertext link, along with other automobile inventory information displayed on a webpage. In some embodiments, photographs are selected from a set of stock photographs stored in digital format in a database, such as database 260. In other embodiments, photographs are received from one or more data sources 201. In still other embodiments, photographs reside on photostore servers at third party web servers, wherein a user accesses the photographs from a Web browser by selecting a hypertext link.

Digital files for photographs may be named with conventions that facilitate indexing. Alternatively or additionally, digital files may be stored along with indexing information. Appropriate photograph(s) may be selected for an automobile based at least in part on cross-referencing known automobile information with photograph indexing information. In a particular embodiment, an algorithm involving model numbers and option codes may be run in order to select a photograph that most closely matches an inventory item.

In a particular embodiment, photo matching application 240 utilizes plug-in software modules associated with respective third party information providers. For instance, if JATO Dynamics is utilized as an information provider for a particular dealer, then an associated JATO plug-in may be used to perform photo matching.

In an exemplary implementation, database 260 includes records associated with inventoried vehicles. A record for a particular vehicle may include a field with a hypertext link to a photograph selected by photo matching application 240.

In another exemplary implementation, photo matching application 240 includes a colorizing engine 250. Colorizing engine 250 may colorize a selected photograph in order to substantially match the color of the depicted automobile with an identified color of a particular automobile. For instance, data from data sources 201 may indicate that the color of a 2002 Buick Century sedan available at a Buick dealer is azure. Colorizing engine 250 may colorize a selected photograph of a 2002 Century sedan so that the vehicle is azure-colored. The colorized photograph may then be stored or otherwise made available to a user.

In some embodiments, colorizing engine 250 may change color or colors in a stock photograph in order to match the color or colors of a vehicle in inventory. Alternatively or additionally, colorizing engine 250 may add color or colors to a black-and-white photograph.

Colorizing engine 250 may maintain a set of colorized photographs for types of vehicles. Naming conventions may be used to identify the photographs. For example, a filename may include a color code conjoined with a vehicle model identifier.

In accordance with such embodiments, an automobile inventory system may more faithfully illustrate the appearance of an available vehicle. Moreover, operators of the system may only need to provide one photograph (or a set thereof) of a particular kind of vehicle. Operators need not provide a photograph for each color in which the vehicle is available.

Filter 270 filters and/or modifies database data in database 260 based upon one or more dealer criteria. In various embodiments, filter 270 may filter or modify data based upon customer dealer logic or business rules that are specific to one or more dealers. For instance, a dealer may have a policy of discounting automobile prices by one percent a month. Alternatively or additionally, a dealer may discount a price if an automobile has not been sold after, for example, 90 days at the dealership. Further, a dealer may identify used cars that are less than three years old as “certified”; filtering or modifying may ensure that such cars are identified as “certified” when listed on a webpage. In exemplary situations, automobile records for certain vehicles are not displayed to a user, such as records for used cars that require extensive servicing prior to being offered for sale.

In some embodiments, the filtered or modified information may be formatted, or may contain embedded formatting parameters. As such, the information may conform to specific individualized presentation formats and/or capabilities of target web servers 280.

In one implementation, filter 270 is implemented as a plug-in module separate from other software modules in inventory system 200. As such, source code of other software modules in system 200 need not be recompiled when filter 270 is modified to reflect changes to logic or business rules.

Web servers 280 store information from database 260 that has been filtered or modified by filter 270. Webpages of web servers 280 may incorporate such information.

Web data may be updated in real time. In particular, automobile report data may be received from data sources 201, processed within a brief interval, such as ten minutes, and made accessible to web users. Accordingly, web servers 280 may more accurately reflect existing inventory at a dealer.

Web servers 280 are associated with various entities. Web servers 280 may be associated, for example, with particular dealers or sets of dealers, wherein a web server 280 hosts webpages that reflect inventory of the dealer. Alternatively or additionally, web servers 280 may be associated with other third party webpages, such as, for example, MSN Carpoint, Intermark Buyers Broker Service, Carsmart.com, Sam's Club, AutoNation.com, and Yahoo!. Such webpages may provide users with dealer inventory information.

Some or all web servers 280 may be a part of a server farm operated by non-dealers. Web servers 280 may also be operated by one or more dealers, and may host webpages for such dealers.

Inventory system 200 may utilize multithreading. As such, data for many target web servers 280 may be processed and updated concurrently, such as on a transaction-by-transaction basis.

In one embodiment, inventory system 200 may monitor sales data for cars. For example, a DMS or a dealer may notify inventory system 200 that a particular used car has been sold at a specified price, such as by sending an update report. Inventory system 200 may monitor aggregated statistical data for such sales over a period of time. Thus, more accurate valuations of the value of used cars may be made. In a related embodiment, used car sales data may be organized (disaggregated) by geographical region, and valuations may be made based on region. Such valuation data may be transmitted to various entities, such as loan officers of banks and insurance companies. Further, sales data may be transmitted to a data warehouse and stored for use in historical analyses.

In another embodiment, system 200 may include a database, such as database 260 or another local or remote database, which provides data warehousing functions for system 200. Alternatively or additionally, multiple remote or local databases may be employed. The data warehouse may store information, including VIN numbers, for each vehicle for which data is gathered and processed by system 200.

For instance, information concerning a particular new vehicle available at Dealer A may be stored in the data warehouse. At some point in the future, the same vehicle may be traded in and may become available as a used car at Dealer B. The previously stored data may then be reused by system 200 to provide information for a website associated with Dealer B. Accordingly, a complete dataset for the used car need not be gathered and generated from scratch. In addition, Dealer B or other parties need not buy information associated with used cars from third party information providers.

System 200 is scalable. Memory and faster chips may be added to a hardware platform of system 200 in order to scale the system. Databases, such as database 260, may be expanded without the need for reprogramming software in system 200.

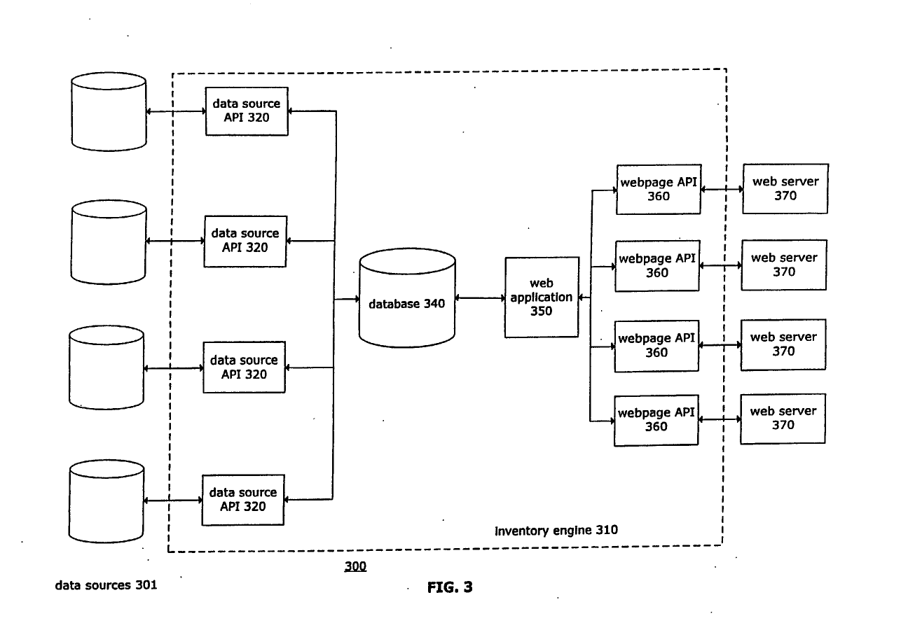

FIG. 3 illustrates an inventory system 300 according to another embodiment of the present invention. System 300 includes various data sources, an inventory engine 310, and various web servers 370.

Data sources 301 are similar to data sources 201 described above. Data sources 301 may supply reports that contain, for example, information listing new and used car inventory. In some embodiments, separate reports may be supplied for new and used cars, respectively. Further, separate reports may specify vehicle options for vehicles listed in inventory reports. Reports may contain vehicle records, which may include multiple rows and columns specifying vehicle information. Reports may have file name prefixes, suffixes, and/or header information that facilitates identification of the associated data source 301.

Inventory engine 310 includes various data source application programmatic interface (API) modules 320, a database 340, a web application 350, and various webpage API modules 360.

Each data source API module 320 is specific to a data source 301. Each data source API module 320 parses data received from the corresponding data source 301, and reformats the data to conform to a custom, normalized format employed by inventory engine 310. As such, incompatible formats of data sources 301 are reformatted such that other software modules in inventory engine 310 are not dependent on formats employed by data sources 301. In some embodiments, if inventory engine 310 needs to process data from a new data source 301, then an API for that new data source may be created in modular fashion to support the new data source. As such, existing APIs and other software modules in inventory engine 310 need not be rewritten to enable compatibility with the new data source 301.

Accordingly, inventory engine 310 is not dependent on particular data sources 301. Inventory engine 310 need not be designed, for example, to make direct SQL calls to only a particular database. If, for example, a particular data provider wished to charge inflated fees for providing data, inventory engine 310 may be outfitted with a new data source API 320 in order to receive and process data from a less costly data provider.

Moreover, because inventory engine 310 can receive and process data from various data sources 301, inventory engine 310 can generate more complete data sets.

In one implementation, data source API modules 320 involve XML configuration files associated with particular data sources 301. Each configuration file contains mapping information between the format of the particular source and the custom format of inventory engine 310. API modules 320 may parse the configuration file and use mapping information therein to parse the associated automobile report data. API modules 320 may output an inventory object that contains vehicle information for the particular data source 301.

Database 340 may store the data reformatted by data source API modules 320.

Web application 350 processes data in database 340, another database, or other volatile or nonvolatile memory to produce inventory data and/or webpage formatting information for use by web servers 370, such as web servers associated with dealers and/or third parties. Web application 350 may perform various processing functions, such as, for example, VIN decoding, third party data matching, photo matching, and filtering and modifying, as described above.

Each webpage API module 360 is specific to a particular web server 370. Each webpage API module 360 reformats data to conform to the webpage format of the particular web server 370. Reformatting may involve modifying format parameters in a database, such as database 340, and transmitting the modified data to particular web servers 370.

Therefore, when new web servers 370 are incorporated in inventory system 300, or if existing web servers 370 require format changes to webpages, a new webpage API module 360 may be created in modular fashion to support the webpages. As such, existing APIs and other software modules in inventory engine 310 need not be rewritten to enable compatibility with new webpages for web servers 370.

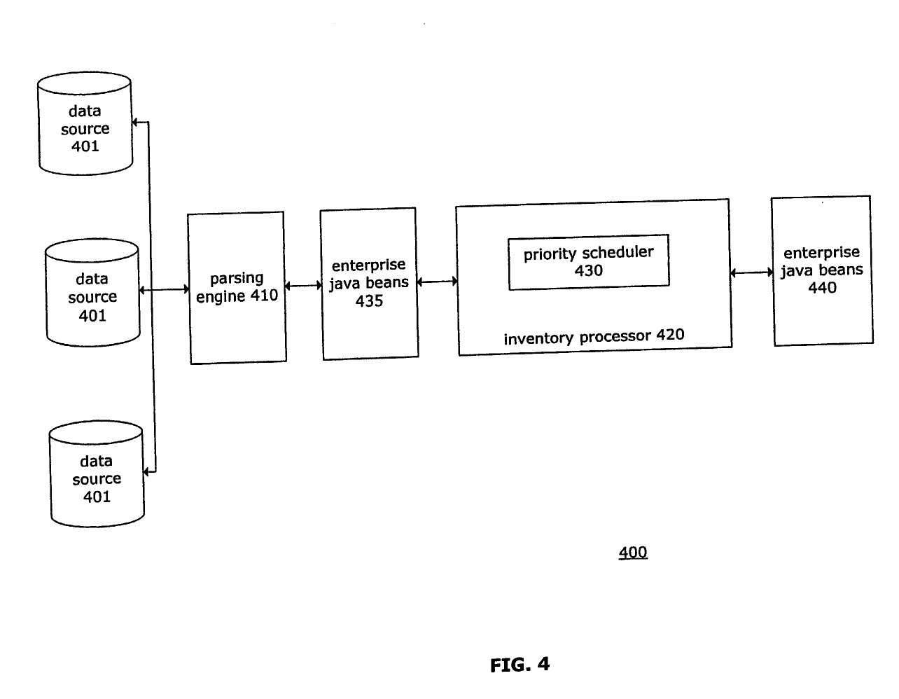

FIG. 4 illustrates an inventory system 400 according to an embodiment of the present invention.

System 400 includes data sources 401, a parsing engine 410, message-driven Enterprise Java Beans (EJBs) or business plug-ins 435, 440, and inventory processor 420.

Parsing engine 410 receives data feeds from various data sources 401.

Inventory processor 420 includes a priority scheduler 430. Inventory processor 420 receives data from parsing engine 410 in the form of EJBs 435. Inventory processor 420 processes data according to whether the data has an associated high, medium, or low priority. Priority scheduler 430 may assign a relative priority to the data.

For instance, in one implementation, nightly or weekly data feeds may be processed in a low priority. Real-time data feeds may be processed in a high or medium priority.

J Inventory processor 420 outputs data to various EJBs 440. EJBs 440 may correspond to various software modules, such as VIN decoder 220, third party data matching application 230, and filter 270 of system 200. EJBs 440 may be multithreaded (run concurrently), such that data may be transmitted back and forth between software modules in any order as necessary. For instance, fifteen or fifty dealer web pages may be serviced concurrently.

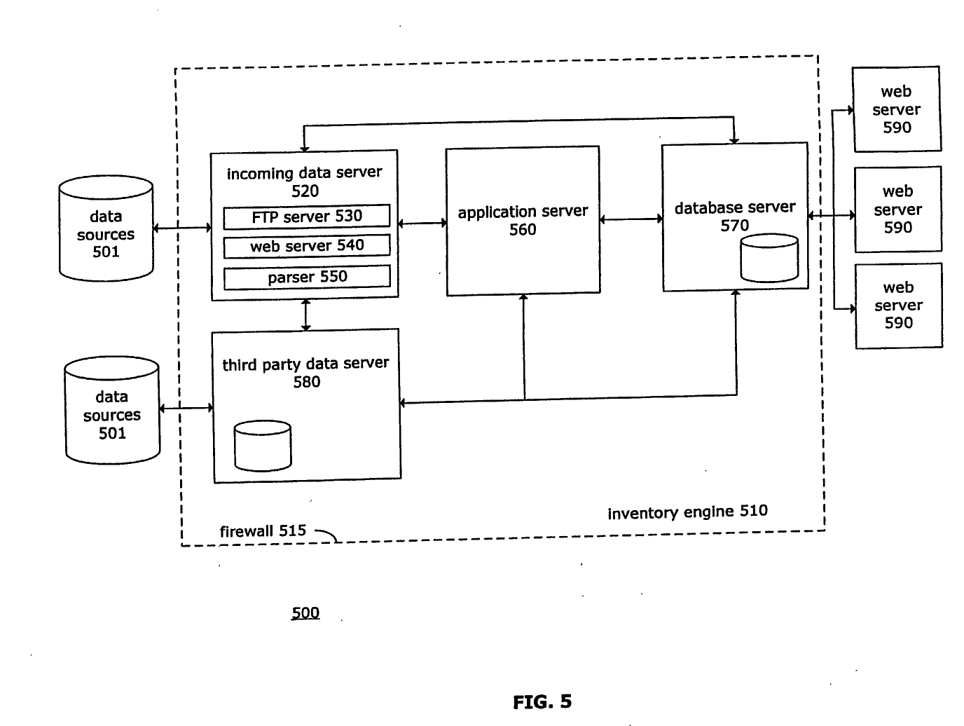

FIG. 5 illustrates an inventory system 500 according to an embodiment of the present invention. System 500 illustrates an exemplary hardware implementation that may be implemented, for example, in conjunction with the above-described embodiments shown in FIGS. 1-4.

System 500 includes data sources 501, an inventory engine 510, and web servers 590.

Inventory engine 510 includes an incoming data server 520, a third party data server 580, an application server 560, and a database server 570 coupled within a network and surrounded by a firewall 515. It is to be understood that some or all of the devices shown may be implemented together or as discrete units or modules. For instance, a server may include an application portion and a database portion.

In an exemplary implementation, inventory engine 510 is implemented on a Linux operating system platform and utilizes distributed processing. Source code for application software may be written in Java. In other implementations, inventory engine 510 may run in a Windows, Sun, Hewlett Packard, or other Java-compatible operating system environment; Java source code may be recompiled for such environments.

J Incoming data server 520 receives data from various data sources 501. Incoming data server 520 includes an FTP server 530, a web server 540, and a parser 550. Incoming data server 520 may be implemented, for example, on a Dell server.

FTP server 530 may download files, such as data files in the form of spreadsheets, from data sources 501.

Web server 540 may receive data posted, via HTTP, by data sources 501.

Parser 550 reformats the respective formats of data received from data sources 501 into a custom, normalized format for storage and/or further processing.

Third party data server 580 receives data from various data sources 501. Third party data server 580 may store data before or after parsing by parser 550. In one implementation, third party data server 580 may run an Oracle database.

Application server 560 includes a quad processor with 4 GB of RAM to facilitate processing tasks. Application server 560 and other servers in system 500 may be scaled up by incorporating additional processors, disk space, and/or RAM therein. Selection of hardware may be based in part on the number of dealers or other parties serviced by system 500, as well as on quantities of data gathered by system 500, such as during nightly data feeds. Source code run by application server 560 need not be changed if processors, disk space, and/or RAM are added. In one embodiment, application server 560 and other servers in system 500 are implemented as a Dell PowerEdge2400 server.

A Linux daemon process may run in incoming data server 520, third party data server 580, and/or other servers in system 500. The process may monitor the associated directory file system to detect incoming files, such as batch report data sent by data sources 501, and may trigger data processing when a transaction is detected. As such, inventory engine 510 may always be on, that is, inventory engine 510 may provide real-time updates of data.

With a change in car dealer inventory—a car arrives or is sold—a data source 501 may provide inventory engine 510 with updated report data. Inventory engine 510 may process the updated report data, update inventory database information in database server 570, and make the data available to web users.

Database server 570 stores one or more databases, such as Oracle databases, that include automobile inventory information. The information may be exported or accessed for display on webpages of web servers 590.

Various web servers 590 enable the display of inventory information provided by database server 570. Web servers 590 may be respectively located in locations removed from inventory engine 510. Web servers 590 may communicate with database server 570.

In other embodiments, inventory engine 510 may include a dealer configuration utility (DCU, not shown) to facilitate the setting up of a new webpage for a web server 590. The DCU adds and edits dealer webpages to be hosted by web servers 590. A Wizard-like query template may be used to set up data for the pages. The DCU may be used by operators of inventory engine 510. Alternatively or additionally, entities outside inventory engine 510, such as dealers, may use the DCU.

In other embodiments, system 500 may include a data extraction system that utilizes a serial connection and/or network connection to connect to various data sources. Via a modem or the Internet, for example, the data extraction system may extract report data from data sources, such as DMSs, to populate databases of inventory engine 510. Extraction may occur concurrently; for instance, forty-eight extractions may be run concurrently.

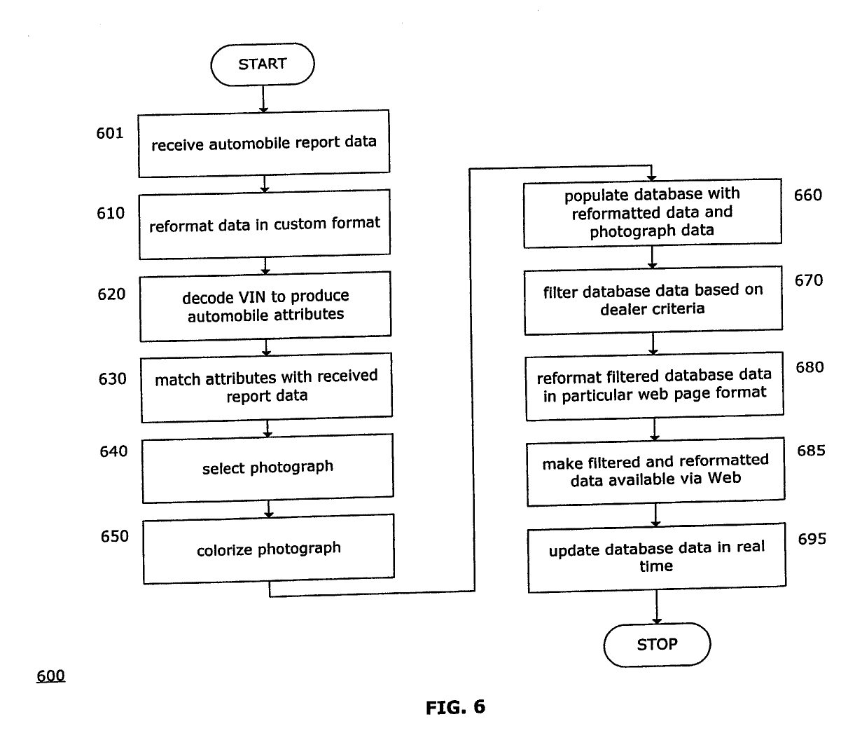

FIG. 6 is a flowchart of a process 600 for an automobile inventory system according to an embodiment of the present invention. In task 601, automobile report data is received. For instance, report data may be received from DMSs. In task 610, the received data is reformatted in a custom format. In task 620, a VIN is decoded to produce a set of automobile attributes. The attributes are matched with report data in task 630. In task 640, a photograph is selected to represent an automobile. In task 650, the photograph is colorized. In task 660, the database is populated with the reformatted data and photograph data.

In task 670, database data is filtered or modified based on one or more dealer criteria. In task 680, the filtered or modified database data is reformatted in the particular format of each target webpage. In task 685, the filtered or modified, reformatted database data is made available to users via the Web. In task 695, the database data is updated in real time and made available to users via the Web.

The foregoing description of the various embodiments is provided to enable any person skilled in the art to make and use the present invention and its embodiments. Various modifications to these embodiments are possible, and the generic principles presented herein may be applied to other embodiments as well. For Instance, a user may schedule service on vehicles from a webpage. A utility application may allow the user to enter a scheduling request, which may then be transmitted, such as via an EJB, to web application 350 and database 340.

Further, the invention may be implemented in part or in whole as a hard-wire circuit, as a circuit configuration fabricated into an application-specific integrated circuit, or as a firmware program loaded into non-volatile storage, or a sofware program loaded from or into a data storage medium as machine-readable code. Such code may be instructions executable by an array of logic element such as a microprocessor or other digital signal processing unit.

As such, the present invention is not intended to be limited to the embodiments shown above but rather is to be accorded the widest scope consistent with the principles and novel features disclosed in any fashion herein.

What is claimed is:

1. A method of delivering real-time automobile inventory information over the World Wide Web, the method comprising:
(a) receiving automobile report data from a plurality of information sources, the information sources having distinct incompatible data formats, an information source including a dealer management system, a third party information provider, and a sticker service company, the report data relating to at least one automobile associated with a dealer location,
wherein the receiving includes at least one of accessing an information source and receiving report data via FTP (File Transfer Protocol);
(b) reformatting the report data in a single uniform format, the reformatting involving at least one API (application programmatic interface), the at least one API including at least one XML (Extensible Markup Language) configuration file associated with an information source, the configuration file including information to map the report data to the single uniform format;
(c) decoding a vehicle identification number (VIN) associated with the at least one automobile, the decoding producing a set of automobile attributes;
(d) matching at least one among the produced set of automobile attributes with received third party automobile report data;
(e) selecting, from a set of photographs, a photograph to represent the at least one automobile, the selecting including running an algorithm based at least in part on model number information of the at least one automobile, wherein the selected photograph is colorized to substantially match an identified color of the at least one automobile;
(f) populating at least one database with database data, the database data including the reformatted report data, data associated with the matching of automobile attributes, and optionally data associated with the colorized photograph;
(g) filtering or modifying the database data based at least in part on at least one dealer business rule, the filtering or modifying involving applying a dealer discount rule to the database data;
(h) electronically communicating at least a portion of the database data to a World Wide Web accessible server;
(i) updating the database data in real time, the updating involving multithreading;
(j) sending, by an information source, report data via HTML (Hypertext Markup Language);
(k) comparing first report data with second report data, the comparing producing update information for a database update;
(l) correcting errors in received data based at least in part on agreement of data between information sources;
(m) formatting the filtered or modified database data for a target web server;
(n) monitoring sales data of automobiles associated with the dealer location;
(o) recording sales data associated with sales of automobiles; and
(p) storing, at least in part, the received or reformatted report data in a data warehouse.

2. A method of delivering automobile inventory information over the World Wide Web, the method comprising:
(a) receiving automobile report data from a plurality of information sources, the information sources having distinct incompatible data formats, the report data relating to at least one automobile associated with a dealer location;
(b) reformatting the report data in a single uniform format, the reformatting involving at least one API (application programmatic interface);
(c) decoding a vehicle identification number (VIN) associated with the at least one automobile, the decoding producing a set of automobile attributes;
(d) matching at least one among the produced set of automobile attributes with received third party automobile report data;
(e) populating at least one database with database data, the database data including the reformatted report data and data associated with the matching of automobile attributes; and
(f) electronically communicating at least a portion of the database data to a World Wide Web accessible server.

3. The method of claim 2, further comprising selecting, from a set of photographs, a photograph to represent the at least one automobile.

4. The method of claim 3, wherein the selected photograph is colorized to substantially match an identified color of the at least one automobile.

5. The method of claim 3, wherein the selecting includes running an algorithm based at least in part on model number information of the at least one automobile.

6. The method of claim 3, wherein the database data includes data associated with the selected photograph.

7. The method of claim 2, further comprising filtering or modifying the database data based at least in part on at least one dealer business rule.

8. The method of claim 7, wherein the filtering or modifying involves applying a dealer discount rule to the database data.

9. The method of claim 7, further comprising formatting the filtered or modified database data for a target web server.

10. The method of claim 2, further comprising updating the database data in real time.

11. The method of claim 10, wherein the updating the database data involves multithreading.

12. The method of claim 2, wherein an information source includes a dealer management system.

13. The method of claim 2, wherein an information source includes a third party information provider.

14. The method of claim 2, wherein an information source includes a sticker service company.

15. The method of claim 2, further comprising receiving automobile report data from information sources having compatible data formats.

16. The method of claim 2, wherein the receiving includes accessing an information source.

17. The method of claim 2, wherein the receiving includes receiving report data via FTP (File Transfer Protocol).

18. The method of claim 2, further comprising sending, by an information source, report data via HTML (Hypertext Markup Language).

19. The method of claim 2, further comprising comparing first report data with second report data, the comparing producing update information for a database update.

20. The method of claim 2, further comprising correcting errors in received data based at least in part on agreement of data between information sources.

21. The method of claim 2, wherein the at least one API includes at least one XML (Extensible Markup Language) configuration file associated with an information source, the configuration file including information to map the report data to the single uniform format.

22. The method of claim 2, further comprising monitoring sales data of automobiles associated with the dealer location.

23. The method of claim 2, further comprising recording sales data associated with sales of automobiles.

24. The method of claim 2, further comprising storing, at least in part, the received or reformatted report data in a data warehouse.

25. A system to deliver real-time automobile inventory information over the World Wide Web, the system comprising:
(a) a reformatter to reformat automobile report data in a single uniform format, the automobile report data being received from a plurality of information sources having distinct incompatible data formats, the report data relating to at least one automobile associated with a dealer location, the reformatter configured to apply a plurality of application programmatic interfaces (APIs) to transform the respective data formats to the single uniform format, wherein the reformatter includes an inventory processor configured to process report data based at least in part on a priority associated with an information source, and wherein the reformatter utilizes Enterprise Java Beans (EJBs);
(b) a vehicle identification number (VIN) decoder to decode a VIN associated with the at least one automobile, the decoder producing a set of automobile attributes;
(c) a third party data matching application to match at least one among the produced set of automobile attributes with received third party automobile report data;
(d) a database having database data including the reformatted report data and data matched by the third party data matching application;
(e) a filter to filter or modify the database data based at least in part on at least one dealer business rule, wherein the at least one dealer business rule is stored in a module that is specific to the filter and involves custom logic;
(f) a configuration utility to configure a webpage by which the filtered or modified database data is made available to the user; and
(g) a photo matching application to select a photograph from a set of photographs to represent the at least one automobile, wherein a color of the selected photograph substantially matches an identified color of the at least one automobile, wherein a colorizing engine colorizes a photograph to produce the selected photograph, wherein the database data includes data associated with the selected photograph, wherein
the database data is updated in real time,
the received or reformatted report data is stored, at least in part, in a data warehouse, and
at least a portion of the database data is electronically communicated to a World Wide Web accessible server.

26. A system to deliver real-time automobile inventory information over the World Wide Web, the system comprising:
(a) a reformatter to reformat automobile report data in a single uniform format, the automobile report data being received from a plurality of information sources having distinct incompatible data formats, the report data relating to at least one automobile associated with a dealer location, the reformatter configured to apply a plurality of application programmatic interfaces (APIs) to transform the respective data formats to the single uniform format;
(b) a vehicle identification number (VIN) decoder to decode a VIN associated with the at least one automobile, the decoder producing a set of automobile attributes;
(c) a third party data matching application to match at least one among the produced set of automobile attributes with received third party automobile report data; and
(d) a database having database data including the reformatted report data and data matched by the third party data matching application,
wherein at least a portion of the database data is electronically communicated to a World Wide Web accessible server.

27. The system of claim 26, further comprising a filter to filter or modify the database data based at least in part on at least one dealer business rule.

28. The system of claim 27, wherein the at least one dealer business rule is stored in a module that is specific to the filter.

29. The system of claim 27, wherein the at least one dealer business rule involves custom logic.

30. The system of claim 26, wherein the database data is updated in real time.

31. The system of claim 26, wherein the received or reformatted report data is stored, at least in part, in a data warehouse.

32. The system of claim 26, wherein the reformatter includes an inventory processor configured to process report data based at least in part on a priority associated with an information source.

33. The system of claim 26, wherein the reformatter utilizes Enterprise Java Beans (EJBs).

34. The system of claim 26, further comprising a configuration utility to configure a webpage by which the filtered or modified database data is made available to the user.

35. The system of claim 26, further comprising a photo matching application to select a photograph from a set of photographs to represent the at least one automobile, wherein a color of the selected photograph substantially matches an identified color of the at least one automobile.

36. The system of claim 35, wherein a colorizing engine colorizes a photograph to produce the selected photograph.

37. The system of claim 35, wherein the database data includes data associated with the selected photograph.

38. A computer-readable medium encoded with a plurality of processor-executable instructions for:
(a) receiving automobile report data from a plurality of information sources, the information sources having distinct incompatible data formats, an information source including a dealer management system, a third party information provider, and a sticker service company, the report data relating to at least one automobile associated with a dealer location,
wherein the receiving includes at least one of accessing an information source and receiving report data via FTP (File Transfer Protocol);
(b) reformatting the report data in a single uniform format, the reformatting involving at least one API (application programmatic interface), the at least one API including at least one XML (Extensible Markup Language) configuration file associated with an information source, the configuration file including information to map the report data to the single uniform format;
(c) decoding a vehicle identification number (VIN) associated with the at least one automobile, the decoding producing a set of automobile attributes;
(d) matching at least one among the produced set of automobile attributes with received third party automobile report data;
(e) selecting, from a set of photographs, a photograph to represent the at least one automobile, the selecting including running an algorithm based at least in part on model number information of the at least one automobile, wherein the selected photograph is colorized to substantially match an identified color of the at least one automobile;
(f) populating at least one database with database data, the database data including the reformatted report data, data associated with the matching of automobile attributes, and optionally data associated with the colorized photograph;
(g) filtering or modifying the database data based at least in part on at least one dealer business rule, the filtering or modifying involving applying a dealer discount rule to the database data;
(h) electronically communicating at least a portion of the database data to a World Wide Web accessible server;
(i) updating the database data in real time, the updating involving multithreading;
(j) sending, by an information source, report data via HTML (Hypertext Markup Language);
(k) comparing first report data with second report data, the comparing producing update information for a database update;
(l) correcting errors in received data based at least in part on agreement of data between information sources;
(m) formatting the filtered or modified database data for a target web server;
(n) monitoring sales data of automobiles associated with the dealer location;
(o) recording sales data associated with sales of automobiles; and
(p) storing, at least in part, the received or reformatted report data in a data warehouse.

39. A computer-readable medium encoded with a plurality of processor-executable instructions for:
(a) receiving automobile report data from a plurality of information sources, the information sources having distinct incompatible data formats, the report data relating to at least one automobile associated with a dealer location;
(b) reformatting the report data in a single uniform format, the reformatting involving at least one API (application programmatic interface);
(c) decoding a vehicle identification number (VIN) associated with the at least one automobile, the decoding producing a set of automobile attributes;
(d) matching at least one among the produced set of automobile attributes with received third party automobile report data;
(e) populating at least one database with database data, the database data including the reformatted report data and data associated with the matching of automobile attributes; and
(f) electronically communicating at least a portion of the database data to a World Wide Web accessible server.

40. The computer-readable medium of claim 39, further comprising processor-executable instructions for selecting, from a set of photographs, a photograph to represent the at least one automobile.

41. The computer-readable medium of claim 40, wherein the selected photograph is colorized to substantially match an identified color of the at least one automobile.

42. The computer-readable medium of claim 39, further comprising processor-executable instructions for filtering or modifying the database data based at least in part on at least one dealer business rule.

43. The computer-readable medium of claim 39, further comprising processor-executable instructions for updating the database data in real time.
